(19) United States
(12) Patent Application Publication
(10) Pub. No.: US 2016/0295799 A1
(43) Pub. Date: Oct. 13, 2016

(54) IMPLEMENT FOR STALK CUTTING IN AN ONION PLANTATION

(71) Applicants: Miguel GRAU CALAFELL, Golmes (ES); Miguel GRAU DEJUAN, Golmes (ES)

(72) Inventors: Miguel GRAU CALAFELL, Golmes (ES); Miguel GRAU DEJUAN, Golmes (ES)

(21) Appl. No.: 15/097,322

(22) Filed: Apr. 13, 2016

(30) Foreign Application Priority Data
Apr. 13, 2015 (ES) P201530492

(51) Int. Cl. A01D 47/00; A01D 34/52; A01D 34/54; A01D 34/00; A01D 69/00

(52) U.S. Cl. CPC A01D 47/00; A01D 34/006; A01D 69/002; A01D 34/54; A01D 34/52; A01D 2101/00

(57) ABSTRACT

An implement (1) for the cutting of stalks (2) in an onion plantation (3) which includes a chassis (4) on which there are mounted at least two rotating combing mechanisms (5, 6) of an essentially horizontal axis, a front combing mechanism (5) in which the lower part rotates in an opposite direction to the forward movement of the implement (1), and a rear combing mechanism (6) in which the lower part rotates in the same direction as the forward movement of the implement (1); also mounted on the chassis (4) is at least one essentially horizontal cutting bar (7), which is located behind the rear combing roller (6) to cut the stalks (2).

### OBJECT OF THE INVENTION

The present invention refers to a machine or system for cutting the stalks of an onion plantation, also useable for other vegetables, prior to picking.

### FIELD OF THE INVENTION

The present invention falls within the field of agricultural machinery.

### BACKGROUND OF THE INVENTION

In the cultivation of onions and other bulbous plants it is common practice to cut the stalk before picking.

Currently this cutting can be performed manually with pruning shears or with a sickle, which is very costly in terms of the personnel required to remove the stems and clean everything.

There also exists a mechanical system, whereby a machine with blades which rotate at a high velocity suck up and cut the stalk; however this system has many disadvantages, given that the ripe onions produce juice and earth and dust become stuck, with the onions thus becoming stained and covered in green marks. Another problem is that, due to the suction of the turbines or blades, earth and small stones are sucked up producing a blasting effect leaving the onions pock marked. A further problem is that the cut is irregular and the stalk stems are left damaged and frayed. Furthermore, onion leaves are picked up, reducing the final quality of the onion for later use.

### DESCRIPTION OF THE INVENTION

The invention implement has a configuration which solves the problems described for the cutting of onions and similar vegetables.

According to the invention the implement comprises a chassis on which are mounted at least two rotating combing mechanisms on an essentially horizontal axis: a front combing mechanism in which the lower part rotates in an opposite direction to the forward movement of the implement, and a rear combing mechanism in which the lower part rotates in the same direction as the forward movement of the implement. Also mounted on the chassis is at least one essentially horizontal cutting bar, preferably of alternate cut, which is located behind the rear combing roller to cut the stalks.

With this configuration the front combing mechanism raises any stalks which may be lying in the opposite direction to the movement of the implement and pre-positions all the stalks for processing by the rear combing mechanism, which holds them firmly upright and in the correct direction to be cut by the cutting bar. The cut produced by the cutting bar is clean and similar to that produced with shears, leaving the stalks in optimum condition.

### BRIEF DESCRIPTION OF THE DRAWINGS

FIG. 1 shows a general view of the invention implement;

FIG. 2 shows a front detail where the front combing mechanism can be seen;

FIG. 3 shows a schematic side view of the invention implement;

FIG. 4 shows a schematic side view of the invention implement during the stalk cutting, where it can be seen how the cutting bar has moved down and is situated at the desired height to cut the stalks;

FIG. 5 shows a schematic underside view of the working of the invention implement, with the entry of the stalks for cutting, the action of the combing mechanisms, the cutting bar for the cutting of the stalks and their gathering and lateral removal via a scoop and dual direction conveyor provided in the interior.

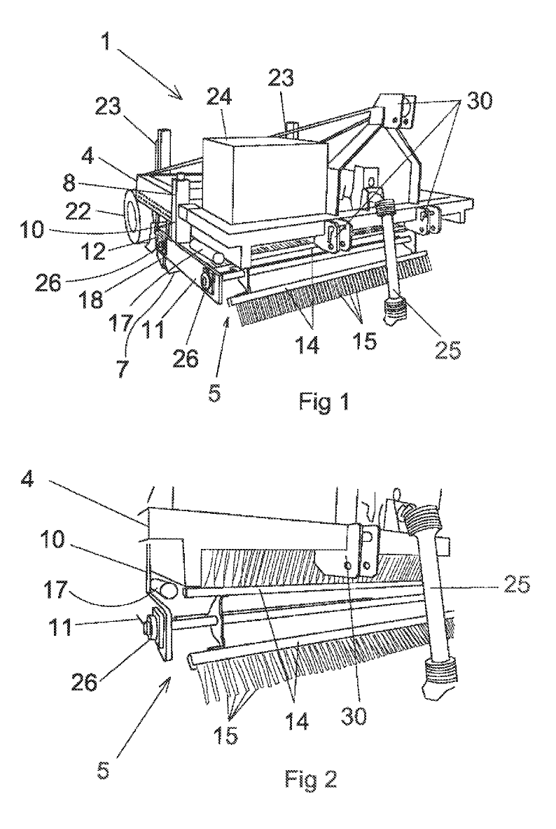

### DESCRIPTION OF A PRACTICAL EMBODIMENT OF THE INVENTION

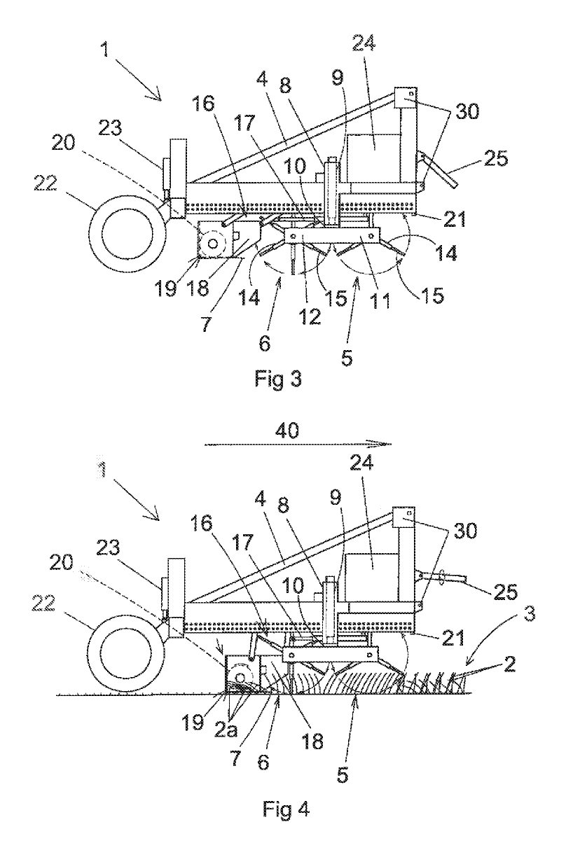

The invention implement (1) for the cutting of stalks (2) in an onion plantation (3) comprises a chassis (4) in which there are at least two rotating combing mechanisms (5, 6) of an essentially horizontal axis: a front combing mechanism (5) in which the lower part rotates in an opposite direction to the forward movement (40) of the implement (1), and a rear combing mechanism (6) in which the lower part rotates in the same direction as the forward movement (40) of the implement (1); also mounted on the chassis (4) is at least one essentially horizontal cutting bar (7), which is located after the rear combing roller (6) to cut the stalks (2) (see FIGS. 3 & 4).

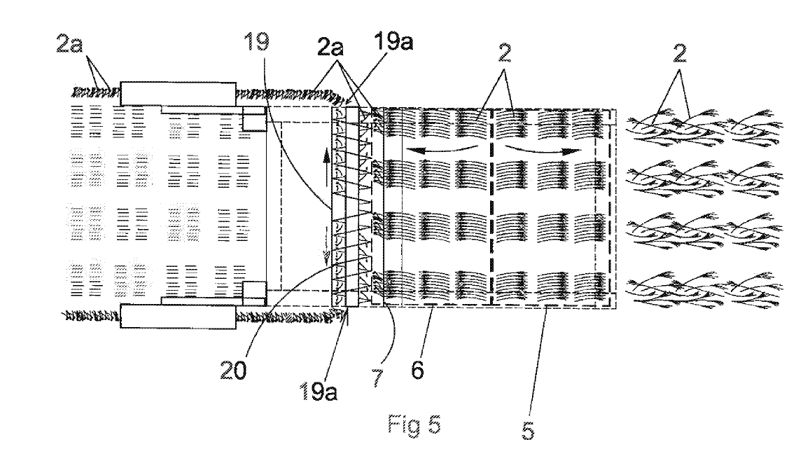

With this configuration the front combing mechanism (5) raises any stalks (2) which may be lying in the opposite direction to the movement (40) of the implement (1) and pre-positions all the stalks (2) for processing by the rear combing mechanism (6), which holds them firmly upright and in the correct direction to be cut by the cutting bar (7), as seen in FIG. 4.

In this example of the invention, the chassis (4) comprises coupling devices for a tractor vehicle, not represented, although the protection of the invention also covers an implement with self-propulsion mechanisms for independent operation.

The combing mechanisms (5, 6) are mounted on the chassis (4) via initial height adjustment devices for adaptation to the terrain. In this example of the invention the said initial height adjustment devices comprise individual extendable lateral uprights (8), which comprise initial pistons (9) or other mechanical devices for their extension and unfolding. These initial pistons (9)—or other mechanical devices will ideally have a dual effect to activate elevation and lowering, while the extendable lateral uprights (8) comprise a vertical telescopic section (10) which is extended in both front (11) and rear (12) sections, in which the front combing mechanism (5) and rear combing mechanism (6) are respectively mounted.

In terms of the combing mechanisms (5, 6), these comprise radial blades (14) along their whole length (see FIGS. 2 & 3); each of them comprising individual combs which act on the stalks (2) to raise, pre-position and direct them towards the cutting bar (7). The individual combs have teeth (15) ideally made of rubber for better adherence to the stalks (2). Specifically, in this example the front combing mechanism (5) comprises three radial blades (14) angularly equidistant with their rubber toothed combs (15) and the rear combing mechanism (6) comprises six or more radial blades (14), angularly equidistant with their rubber toothed combs (15), as seen in FIGS. 3 & 4.

The cutting bar (7) is similarly mounted on the chassis (4) via devices for adaptation to the terrain and adjustment to the length desired for cutting the stalks (2). In this example the said terrain adaptation devices comprise deformable parallelograms (16), connected to shock absorbers (17) which sustain the raising and lowering of the support unit (18) of the cutting bar (7). These shock absorbers (17) act as a buffer against the weight of the said mechanisms, and are positioned horizontally so as to provide shock absorption in the event of the cutting bar meeting obstacles along the terrain.

It is intended that the invention should include a scoop (19) mounted behind the cutting bar (7) to collect the cut stalks (2a) as seen in FIGS. 4 & 5. The said scoop (19) is mounted on the support unit (18) of the cutting bar (7), and on the inside will be equipped with a horizontal axis conveyor (20) in two opposite directions, which will pull the accumulated cut stalks (2a) towards lateral outputs (19a) (see FIG. 5) of the said scoop (19), coinciding with the tracks of the tractor, in such a way that the cut stalks (2a) are pulled laterally to both sides of he said tracks.

It is also intended that the invention should be equipped with sensors for the automatic height adjustment of the comb mechanisms (5, 6), the cutting bar (7) and/or the whole chassis (4). The said sensors may comprise ultrasonic sensors (21), as seen in FIGS. 3 & 4, or may comprise a rod with slide carriage on the ground, not shown.

For general adjustment of the height of the chassis (4), it is intended that rear wheels (22) be fitted with second shock absorber pistons (23) controlled by the previously described sensor system via hydraulic electro valves. These second pistons (23), aside from achieving the correct elevation, will absorb the impact of irregularities in the terrain.

Lastly, it is intended that the chassis (4) will be equipped with a hydraulic control unit (24) with a connection (25) to the tractor power take-off for the activation of the hydraulic elements, such as the pistons (23) and the mechanical devices of hydraulic activation, such as the hydraulic motors (26) for operating the comb mechanisms (5, 6).

Having sufficiently described the nature of the invention, as well as the form of practical embodiment, it should be noted that the arrangements described above and represented in the attached diagrams are all liable to modifications in regard to details which will not alter the essential and fundamental principle.

1. An implement (1) for the cutting of stalks (2) in an onion plantation (3) comprising:
a chassis (4) on which are mounted at least two rotating combing mechanisms (5, 6) of a horizontal axis,
a front combing mechanism (5) in which a lower part rotates in an opposite direction to a forward movement of the implement (1), and
a rear combing mechanism (6) in which a lower part rotates in the same direction as the forward movement of the implement (1);
wherein also mounted on the chassis (4) is at least one horizontal cutting bar (7), which is located behind the rear combing roller (6) to cut the stalks (2).

2. The implement (1) for the cutting of stalks (2) in an onion plantation (3) as described in claim 1:
wherein the chassis (4) comprises coupling devices (30) for attachment to a tractor vehicle; or
wherein the chassis (4) incorporating self-propulsion mechanisms.

3. (canceled)

4. The implement (1) for the cutting of stalks (2) in an onion plantation (3) as described in calim 1, wherein the combing mechanisms (5, 6) being mounted on the chassis (4) via initial height adjustment devices.

5. The implement (1) for the cutting of stalks (2) in an onion plantation (3) as described in claim 4, wherein the initial height adjustment devices comprising extendable lateral uprights (8), which comprise mechanical devices for their extension and unfolding.

6. The implement (1) for the cutting of stalks (2) in an onion plantation (3) as described in claim 5, wherein the mechanical devices for the extension and unfolding of the lateral uprights (8) comprising initial pistons (9).

7. The implement (1) for the cutting of stalks (2) in an onion plantation (3) as described in claim 5, wherein the extendable lateral uprights (8) comprising a vertical telescopic section (10) which is extended in both front (11) and rear (12) sections, in which the front combing mechanism (5) and rear combing mechanism (6) are respectively mounted.

8. The implement (1) for the cutting of stalks (2) in an onion plantation (3) as described in claim 1 wherein the combing mechanisms (5, 6) comprises radial blades (14) along their entire length; with each comprising combs with teeth (15) made of rubber.

9. The implement (1) for the cutting of stalks (2) in an onion plantation (3) as described in claim 8, wherein the front combing mechanism (5) comprising three radial blades (14) angularly equidistant.

10. The implement (1) for the cutting of stalks (2) in an onion plantation (3) as described in claim 8, wherein the rear combing mechanism (6) comprising six radial blades (14) angularly equidistant.

11. The implement (1) for the cutting of stalks (2) in an onion plantation (3) as described in claim 1, wherein the cutting bar (7) being mounted on the chassis via devices for adaptation to the terrain.

12. The implement (1) for the cutting of stalks (2) in an onion plantation (3) as described in claim 11 wherein the devices for adaptation to the terrain both comprising deformable parallelograms (16), connected to shock absorbers (17) which sustain the raising and lowering of the support unit (18) of the cutting bar (7).

13. The implement (1) for the cutting of stalks (2) in an onion plantation (3) as described in claim 12, wherein the shock absorbers (17) being positioned horizontally.

14. The implement (1) for the cutting of stalks (2) in an onion plantation (3) as described in claim 1, further comprising a scoop (19) mounted behind the cutting bar (7) for gathering the cut stalks (2a).

15. The implement (1) for the cutting of stalks (2) in an onion plantation (3) as described in claims 14, wherein the scoop (19) being mounted on the support unit (18) of the cutting bar (7).

16. The implement (1) for the cutting of stalks (2) in an onion plantation (3) as described in claim 14, wherein the inside of the scoop containing a horizontal axis conveyor (20) in two opposite directions for pulling the accumulated cut stalks (2a) towards lateral outputs (19) of the said scoop (19), coinciding with the tracks of the tractor.

17. The implement (1) for the cutting of stalks (2) in an onion plantation (3) as described in claim 1, further comprising sensors for the automatic height adjustment of the comb mechanisms (5, 6), the cutting bar (7) and/or the whole chassis (4).

18. The implement (1) for the cutting of stalks (2) in an onion plantation (3) as described in claim 17, wherein the sensors comprising ultrasonic sensors (21).

19. The implement (1) for the cutting of stalks (2) in an onion plantation (3) as described in claim 17, wherein the sensors include a rod with slide carriage on the ground.

20. The implement (1) for the cutting of stalks (2) in an onion plantation (3) as described in claim 1, further comprising rear wheels (22) with second shock absorbing pistons (23) for elevation of the chassis (4).

21. The implement (1) for the cutting of stalks (2) in an onion plantation (3) in claim 1, further comprising a hydraulic control unit (24) with a connection (25) to the tractor power take-off for the activation of the hydraulic elements.
